(19) United States
(12) Patent Application Publication
(10) Pub. No.: US 2011/0075047 A1
(43) Pub. Date: Mar. 31, 2011

(54) FIREWALL PORT SELECTION USING ATSC TUNER SIGNALS

(75) Inventors: Nikolaos GEORGIS, San Diego, CA (US); Paul Jin HWANG, Burbank, CA (US); Djung NGUYEN, San Diego, CA (US)

(73) Assignees: Sony Corporation; Sony Electronics Inc.

(21) Appl. No.: 12/568,898

(22) Filed: Sep. 29, 2009

(51) Int. Cl. H04N 5/50; H04N 7/173; G06F 17/00

(52) U.S. Cl. 348/731; 725/87; 726/11; 348/E05.097

(57) ABSTRACT

Firewall ports are opened automatically and randomly by using signals received from a digital TV device such as an Advanced Television Systems Committee (ATSC) broadcast source.

### I. FIELD OF THE INVENTION

Present principles are directed to opening computer firewall ports automatically and randomly by using signals received from a digital TV.

### II. BACKGROUND OF THE INVENTION

A firewall blocks unauthorized access to a computer network or system while permitting authorized communications to devices outside the network it protects. A firewall may be implemented in software, hardware, or both, and it manages communication between the network it protects and other computers based on desired rules and other criteria.

As understood herein, certain firewall ports should be manually opened for some applications to be able to work properly. Examples are voice-over-Internet (VoIP) applications, peer-to-peer file transfers, and video on demand. As also understood herein, there is a security compromise at a system level once ports are open because this exposes the system to attacks. Consequently, current solutions seek to open as few ports as possible to minimize the risks.

### SUMMARY OF THE INVENTION

Mobile and fixed networked devices that are equipped with an ATSC tuner enjoy increased system security and maximal application performance by receiving information about firewall port opening over the air from an ATSC broadcast tower without requiring a TV user to manually open any firewall ports. Recognizing that, in the case of ATSC tuner-equipped devices, firewall ports do not have to be statically to be open for long periods of time, encrypted information is broadcast over the air that instructs specific devices of which ports need to open and when. Thus, TVs monitor the broadcast signals and implement port control automatically as commanded by the ATSC broadcast tower to ensure maximal performance of applications.

Accordingly, a TV includes a TV tuner, a processor communicating with the TV tuner, and a display presenting signals from the TV tuner under control of the processor. A firewall is provided through which information is exchanged between the TV and a computing component external to the TV. The firewall is characterized by at least first and second ports each having an open configuration to permit communication through the port between the processor and the computing component and a closed configuration to prevent communication through the port between the processor and the computing component. As intended in embodiments below, the processor, responsive to port commands received from the TV tuner, selectively establishes the configuration of both the ports.

The TV tuner may be an Advanced Television Systems Committee (ATSC) tuner that can receive the port commands from an ATSC broadcast tower. As an example, a first port command received by the TV tuner and provided to the processor may cause the processor to cause the first port to assume the open configuration and the second port to assume the closed configuration. A second port command received by the TV tuner can cause the processor to cause the first port to assume the open configuration and the second port to assume the open configuration, while yet another port command received by the TV tuner can cause the processor to cause both ports to assume the closed configuration.

In some implementations the port commands are received in response to a request from the TV for a network service. The network service may be, e.g., voice over Internet (VOIP), peer to peer computer file sharing, and video on demand (VOD).

In another aspect, a method includes receiving port configuration commands at a digital TV tuner from a source of commands external to a network having a firewall communicatively behind which the TV is disposed. The method also includes, responsive to the port configuration commands, configuring plural ports of the firewall.

In another aspect, an apparatus includes a protected computer component behind a firewall having plural ports, and a processor establishing open and closed configurations of the ports responsive to port commands received from outside the firewall.

### BRIEF DESCRIPTION OF THE DRAWINGS

FIG. 1 is a system block diagram showing an example connection between a TV and a network harboring video databases and other systems, and

FIG. 2 is a flow chart demonstrating the sequence of events occurring in order to establish specific firewall port configurations.

### DETAILED DESCRIPTION OF THE PREFERRED EMBODIMENT

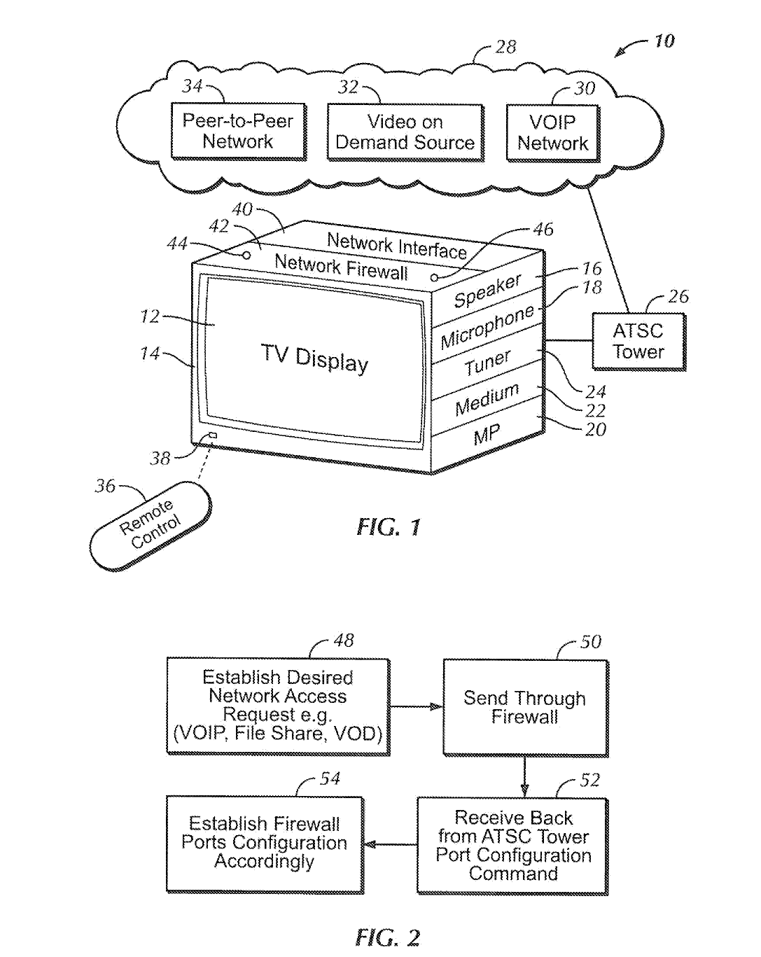

FIG. 1 presents a block diagram of an example networked TV 10 containing a TV display 12 held in a bezel casing 14. The TV 10 also comes equipped with a/some speaker(s) 16 and a microphone 18. A microprocessor 20, a storage medium 22, and a TV tuner 24 are commonly integrated into a given TV 12 and have the capacity for processing electrical signals, storing media files, and receiving information and network service downloads through a broadcast tower 26, respectively. The tower 26 may broadcast digital TV signals such as Advanced Television Systems Committee (ATSC) signals.

The processor 20 communicates instructions to the tuner 24, for example an ATSC tuner, which then signals to the display 12 to display images.

The ATSC tower 26 may be connected to a group of network services 28, including voice over Internet (VOIP) 30, video on demand (VOD) 32, and peer to peer computer file sharing 34. A network service can be selected via input through a remote control 36 wirelessly communicating with a signal receiver 38.

The TV 10 also comes equipped with a network interface 40 whose function is integrated along with a network firewall 42 to protect against unwanted outside sources hacking into the TV 10 and its components. A first port 44 and a second port 46 act as channels through which information received external computing components travels. Any such TV 10 may come outfitted with multiple firewall ports, not necessarily being limited to two ports. Regardless of quantity, all ports have an open configuration permitting communication between the processor 20 and external computing component as well as a closed configuration that prevents communication.

The TV tuner 24 receives port commands from an ATSC tower 26 and sends them to the processor 20 whose function is to selectively establish the configuration of all ports. Due to the selective nature of port configuration, the first port 44 may be open and the second port 46 may be closed and vice versa. As alternative port configurations, all ports may be closed or all ports may be open. The port commands are received in response to a request from the TV 10 for a network service, e.g., VOD 32 inputted by the user via remote control 36.

Moving in reference to FIG. 2, the sequence of events occurring in order to establish specific firewall port configurations is displayed. At block 48, the user establishes a desired network service request by means of pressing buttons on a remote control 36. That request is exported through the firewall to the ATSC tower 26 at block 50. The ATSC tower 26 responds by sending a port configuration command, as in block 52, back to the TV, which then establishes the configuration of all ports in block 54.

For purposes of the invention, the processor does not have to be a TV processor 20, but may be a generic personal computer with an ATSC tuner 24. The firewall can be implemented in a software as well as hardware and would be between a home computer cable router and a personal computer. Alternatively, the router may be embedded into the personal computer.

While the particular FIREWALL PORT SELECTION USING ATSC TUNER SIGNALS is herein shown and described in detail, it is to be understood that the subject matter which is encompassed by the present invention is limited only by the claims.

What is claimed is:

1. TV comprising:
TV tuner;
processor communicating with the TV tuner;
display presenting signals from the TV tuner under control of the processor;
at least one firewall through which information is exchanged between the TV and a computing component external to the TV, the firewall characterized by at least first and second ports each having an open configuration to permit communication through the port between the processor and the computing component and a closed configuration to prevent communication through the port between the processor and the computing component; wherein
the processor, responsive to port commands received from the TV tuner, selectively establishes the configuration of both the ports.

2. The TV of claim 1, wherein the TV tuner is an Advanced Television Systems Committee (ATSC) tuner.

3. The TV of claim 2, wherein the TV tuner receives the port commands from an ATSC broadcast tower.

4. The TV of claim 1, wherein a first port command received by the TV tuner and provided to the processor causes the processor to cause the first port to assume the open configuration and the second port to assume the closed configuration.

5. The TV of claim 4, wherein a second port command received by the TV tuner and provided to the processor causes the processor to cause the first port to assume the open configuration and the second port to assume the open configuration.

6. The TV of claim 4, wherein a second port command received by the TV tuner and provided to the processor causes the processor to cause the first port to assume the closed configuration and the second port to assume the open configuration.

7. The TV of claim 6, wherein a third port command received by the TV tuner and provided to the processor causes the processor to cause both ports to assume the closed configuration.

8. The TV of claim 1, wherein the port commands are received in response to a request from the TV for a network service.

9. The TV of claim 8, wherein the network service is selected from the group including voice over Internet (VOIP), peer to peer computer file sharing, and video on demand (VOD).

10. A method comprising:
receiving port configuration commands at a digital TV tuner from a source of commands external to a network having a firewall communicatively behind which the TV is disposed; and
responsive to the port configuration commands, configuring plural ports of the firewall.

11. The method of claim 10, wherein the TV tuner is an Advanced Television Systems Committee (ATSC) TV.

12. The method of claim 10, wherein the TV tuner receives the port configuration commands from an ATSC broadcast tower.

13. The method of claim 10, wherein a first port configuration command received by the TV tuner causes a first port to assume an open configuration and a second port to assume the closed configuration.

14. The method of claim 13, wherein a second port configuration command received by the TV tuner causes the first port to assume the closed configuration and the second port to assume the open configuration.

15. The method of claim 14, wherein a third port configuration command received by the TV tuner causes both ports to assume the closed configuration.

16. The method of claim 14 wherein the port configuration commands are generated in response to a request from the TV tuner for a network service.

17. The method of claim 16, wherein the network service is selected from the group including voice over Internet (VOIP), peer to peer computer file sharing, and video on demand (VOD).

18. Apparatus comprising:
at least one protected computer component behind a firewall having plural ports; and
at least one processor establishing open and closed configurations of the ports responsive to port commands received from outside the firewall.

19. The apparatus of claim 18, wherein the protected computer component is a digital TV and the port commands are received from a digital TV signal transmission component.

20. The apparatus of claim 19, wherein the port commands are generated in response to a request from the TV for a network service.
